(19) United States
(12) Patent Application Publication
(10) Pub. No.: US 2009/0141395 A1
(43) Pub. Date: Jun. 4, 2009

(54) MOUNTING METHOD FOR STORAGE MEDIUM

(75) Inventor: Hiroshi NAGATA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/325,204

(22) Filed: Nov. 30, 2008

(30) Foreign Application Priority Data
Nov. 30, 2007 (JP) 2007-310846

(51) Int. Cl. G11B 17/08

(52) U.S. Cl. 360/99.08; G9B/17.041

(57) ABSTRACT

In one example embodiment, there is provided a storage-medium mounting method that includes detecting a rotation center axis of a rotor by rotating the rotor relative to a stator, the rotor being rotatably supported by the stator. The storage-medium mounting method includes mounting a storage medium on the rotor while aligning a center axis of the storage medium with the rotation center axis of the rotor.

### CROSS-REFERENCE TO RELATED APPLICATION

This application is based upon and claims the benefit of priority to Japanese Patent Application No. 2007-310846, filed on Nov. 30, 2007, the entire contents of which are incorporated herein by reference.

### BACKGROUND

1. Field

Example embodiments discussed herein are directed to a method for mounting a storage medium that may be computer readable, such as a hard disk (HD), on a rotor.

2. Description of Related Art

A spindle motor is incorporated in a hard disk drive (HDD). A magnetic disk is mounted on a spindle hub of the spindle motor. The spindle hub is rotatably supported by a bracket of the spindle motor. When mounting the magnetic disk, the spindle hub receives a through hole provided at the center of the magnetic disk. The center axis of the through hole is aligned with the center axis of the spindle hub.

Tolerance is produced between the bracket and the spindle hub by, for example, working error. Because of this tolerance, the rotation center axis of the spindle hub deviates from its original rotation center axis, and deviation decreases the rotation accuracy. In order to reduce deviation, the spindle hub is provided with a balancer that is formed by, for example, a weight. However, the use of the balancer increases the number of components of the spindle motor.

### SUMMARY

Accordingly, described herein are various example embodiments of the present invention that provide a storage-medium mounting method that may increase the rotation accuracy of a storage medium (which may be computer readable) without increasing the number of components in such a storage medium.

In one embodiment of the present invention, there is provided a storage-medium mounting method that comprises: detecting a rotation center axis of a rotor by rotating the rotor relative to a stator, the rotor being rotatably supported by the stator; and mounting a storage medium on the rotor while aligning a center axis of the storage medium with the rotation center axis of the rotor.

It is to be understood that both the foregoing general description and the following details are exemplary and explanatory only and are not restrictive of the examples of embodiments (hereinafter, “example embodiment(s)”).

### BRIEF DESCRIPTION OF THE DRAWINGS

Embodiments are illustrated by way of example and not limited by the following figures.

FIG. 1 is a plan view schematically showing an internal configuration of a hard disk drive (HDD) as an example of a storage-medium driving apparatus, in accordance with one example embodiment of the present invention.

FIG. 2 is a partial vertical sectional view, taken along line 2-2 in FIG. 1, in accordance with one example embodiment of the present invention.

FIG. 3 is a plan view schematically showing how laser light is emitted toward an outer peripheral surface of a spindle hub, in accordance with one example embodiment of the present invention.

FIG. 4 is a plan view showing the deviation between the center axis of a stator and the rotation center axis of a rotor, in accordance with one example embodiment of the present invention.

FIG. 5 is a partial vertical sectional view, corresponding to FIG. 2, showing tilting of the rotor, in accordance with one example embodiment of the present invention.

FIG. 6 is a side view schematically showing how laser light is emitted toward the outer peripheral surface of the spindle hub, in accordance with one example embodiment of the present invention.

FIG. 7 is a partial sectional view schematically showing how a magnetic disk is mounted on the spindle hub, in accordance with one example embodiment of the present invention.

FIG. 8 is a plan view schematically showing how the magnetic disk is mounted on the spindle hub, in accordance with one example embodiment of the present invention.

FIG. 9 is a plan view schematically showing how the magnetic disk is mounted on the spindle hub, in accordance with one example embodiment of the present invention.

### DESCRIPTION OF EXAMPLE EMBODIMENTS

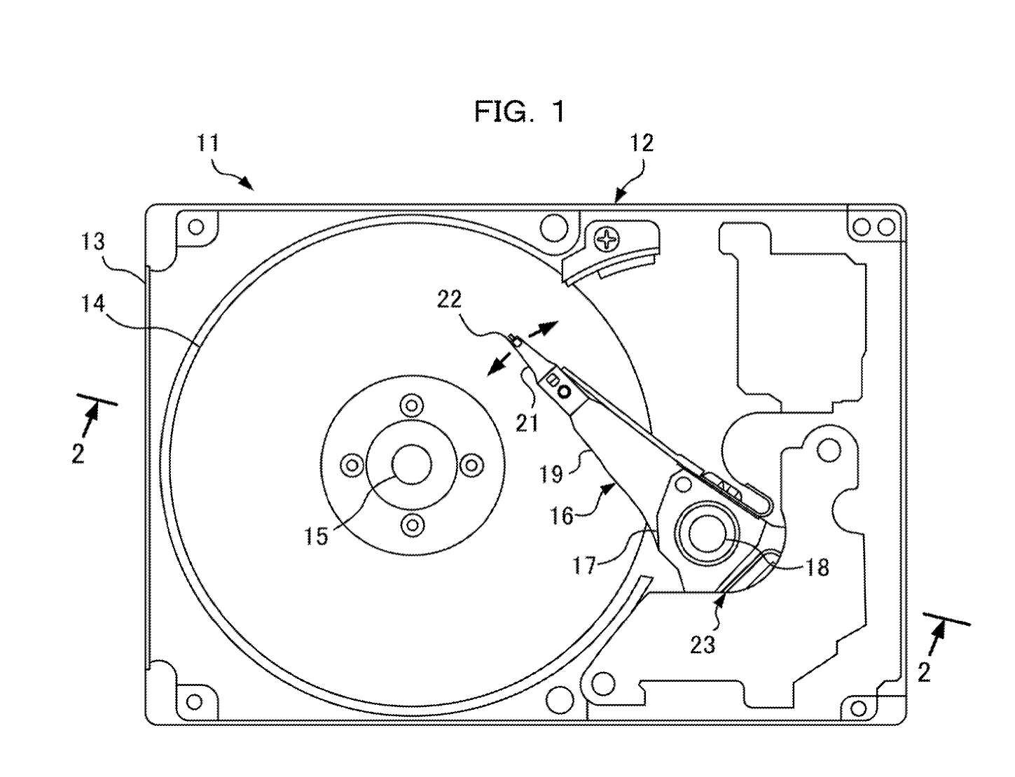

FIG. 1 schematically shows an internal configuration of a hard disk drive (HDD) 11 as an example of a storage-medium driving apparatus, in accordance with one example embodiment. The HDD 11 includes a casing, that is, a housing 12. The housing 12 includes a box-shaped base 13 and a cover (not shown). The base 13 defines an inner space, that is, an accommodating space shaped like a flat rectangular parallelepiped. The base 13 may be formed by casting a metal material such as aluminum. The cover is connected to an opening of the base 13 so that the accommodating space is sealed between the cover and the base 13. The cover may be formed by, for example, pressing a single plate.

The accommodating space accommodates at least one magnetic disk 14 serving as a storage medium. For example, it may include four magnetic disks 14 in one example embodiment. The magnetic disks 14 are mounted on a spindle motor 15. The spindle motor 15 may rotate the magnetic disks 14 at a high speed of, for example, about 3600, 4200, 5400, 7200, 10000, or 15000 rpm.

The accommodating space also accommodates a carriage assembly 16. The carriage assembly 16 includes a carriage block 17 that is rotatably connected to a support shaft 18 extending vertically. A plurality of carriage arms 19 horizontally extending from the support shaft 18 are provided integrally with the carriage block 17. The carriage block 17 may be formed, for example, by extruding aluminum.

At a leading end of each carriage arm 19, a head suspension 21 is attached. The head suspension 21 extends forward from a leading end of the carriage arm 19. A flexure is bonded to a front end of the head suspension, and a flying head slider 22 is supported on the flexure. The attitude of the flying head slider 22 relative to the head suspension 21 may be changed by the flexure. On the flying head slider 22, a magnetic head, that is, an electromagnetic transducer is mounted.

When an airflow is produced on a surface of the magnetic disk 14 by the rotation of the magnetic disk 14, a positive pressure, that is, a buoyant force, and a negative pressure act on the flying head slider 22 by the action of the airflow. By balancing the buoyant force, the negative pressure, and the pressing force of the head suspension 21, the flying head slider 22 may keep flying with a relatively high rigidity during rotation of the magnetic disk 14.

When the carriage assembly 16 turns around the support shaft 18 while the flying head slider 22 is flying, the flying head slider 22 may move along the radius line of the magnetic disk 14. As a result, the electromagnetic transducer on the flying head slider 22 may cross a data zone between the innermost peripheral recording track and the outermost peripheral recording track. Thus, the electromagnetic transducer on the flying head slider 22 is positioned on a target recording track.

To the carriage block 17, a power source, for example, a voice coil motor (VCM) 23 is connected. The carriage block 17 may be turned around the support shaft 18 by the action of the VCM 23. This turn of the carriage block 17 allows swinging of the carriage arm 19 and the head suspension 21.

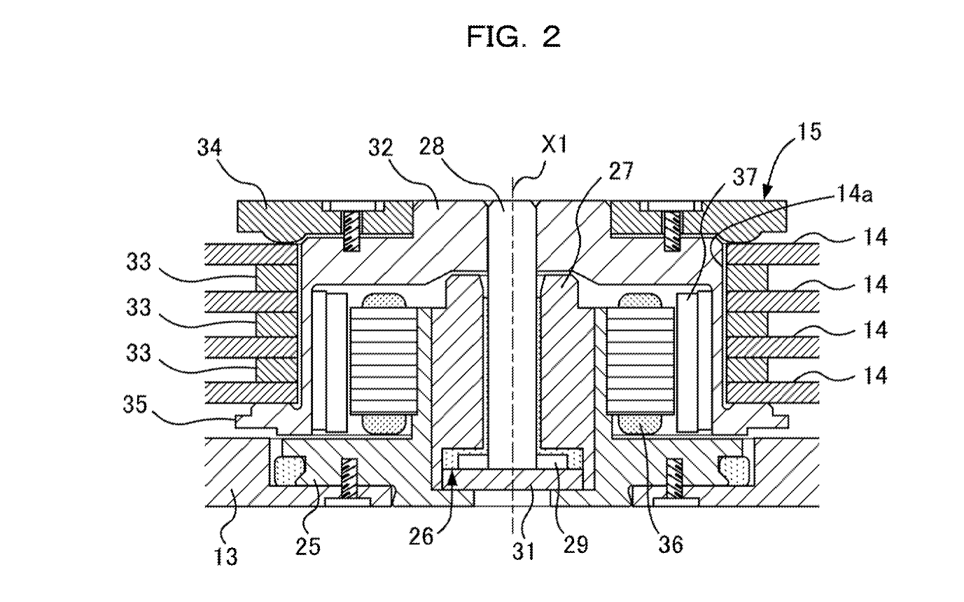

As shown in FIG. 2, the spindle motor 15 includes a bracket 25 that is fixed to, for example, a bottom plate of the base 13. In the bracket 25, a so-called fluid bearing 26 is incorporated. At the fluid bearing 26, a rotation shaft 28 is received in a cylindrical space of a sleeve 27. A space between the sleeve 27 and the rotation shaft 28 is filled with fluid such as lubricant oil. By the action of the fluid, the rotation shaft 28 may rotate about its axis in the sleeve 27 at a high speed. A thrust flange 29 is mounted at the lower end of the rotation shaft 28. The thrust flange 29 spreads from the axis of the rotation shaft 28 in the distal direction, and is received by a thrust plate 31. A space between the thrust flange 29 and the thrust plate 31 is similarly filled with fluid. In one example embodiment, a stator of the spindle motor 15 includes the bracket 25 and the sleeve 27.

A cylindrical spindle hub 32 is attached to the rotation shaft 28. For example, four magnetic disks 14 are mounted on the spindle hub 32. For the purpose of mounting, a through hole 14 for receiving the spindle hub 32 is provided in the center of each magnetic disk 14. Annular spacers 33 are placed between the magnetic disks 14 so as to hold spaces between the magnetic disks 14. A clamp 34 is mounted at the upper end of the spindle hub 32. The clamp 34 may be fixed to the spindle hub 32, for example, by screws. The magnetic disks 14 and the annular spacers 33 are clamped between the clamp 34 and a flange 35 protruding outward from the lower end of the spindle hub 32. In one example embodiment, a rotor of the spindle motor 15 includes the rotation shaft 28 and the spindle hub 32.

A plurality of coils 36 are fixed to the bracket 25 around the rotation shaft 28, and a plurality of permanent magnets 37 are fixed to the spindle hub 32. The permanent magnets 37 are arranged on a wall surface of the spindle hub 32 facing the coils 36. When a current is supplied to the coils 36, magnetic fields are produced in the coils 36, and drive the permanent magnets 37. Thus, the spindle hub 32, that is, the magnetic disks 14 are rotated about a rotation center axis X1. The rotation center axis X1 coincides with the axis of the bracket 25. When the rotation center axis of the rotor coincides with the rotation center axis X1, a high rotation accuracy is ensured in the rotor. Similarly, when the rotation center axis of the rotor coincides with the center axis of the magnetic disks 14, a high rotation accuracy is ensured in the magnetic disks 14, and the magnetic disk 14 may rotate. In this way, the stator supports the rotor in the spindle motor 15 so that the rotor may move relative to the stator.

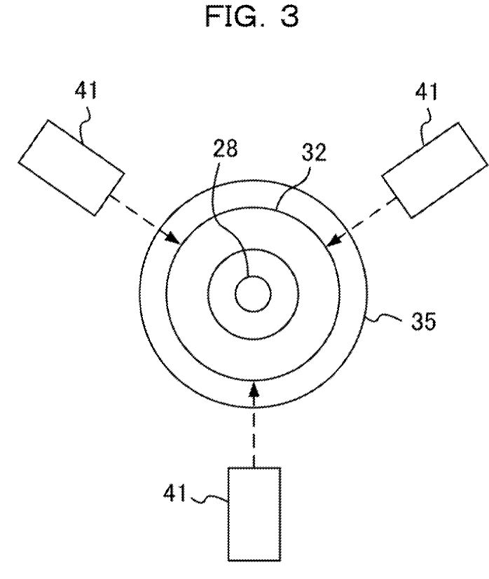

In one example embodiment, a magnetic disk 14 is mounted by first assembling a spindle motor 15. Then, a sleeve 27, a rotation shaft 28, and a spindle hub 32 are attached to a bracket 25. For example, the bracket 25 is fixed to a desired position on a stage. A rotor, as formed by the rotation shaft 28 and the spindle hub 32, is to rotate at a desired rotation speed. As shown in FIG. 3, for example, three non-contact displacement meters 41 face an outer peripheral surface of the spindle hub 32, and are equally spaced around the spindle hub 32. Further, the non-contact displacement meters 41 are provided at a substantially equal distance from the axis of the bracket 25. For example, laser displacement meters are used as the non-contact displacement meters 41.

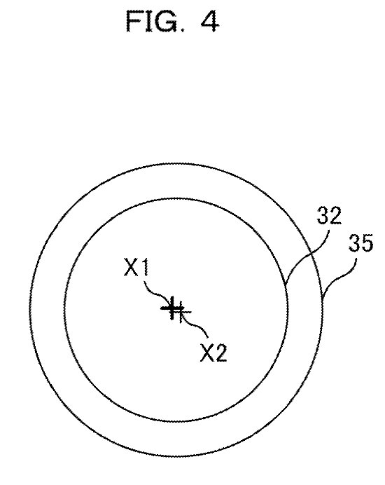

During rotation of the rotor, the non-contact displacement meters 41 emit laser light onto the outer peripheral surface of the spindle hub 32. The non-contact displacement meters 41 move up and down parallel to the axis of the bracket 25. The laser light is reflected by the outer peripheral surface of the spindle hub 32 toward the non-contact displacement meters 41. On the basis of the reflected light, the rotation center axis of the rotor is detected. As shown in FIG. 4, for example, a rotation center axis X1 of the rotor deviates from the axis of the bracket 25, that is, a center axis X2 of the stator because of tolerance resulting from working error. This deviation causes wobbling of the rotor during rotation.

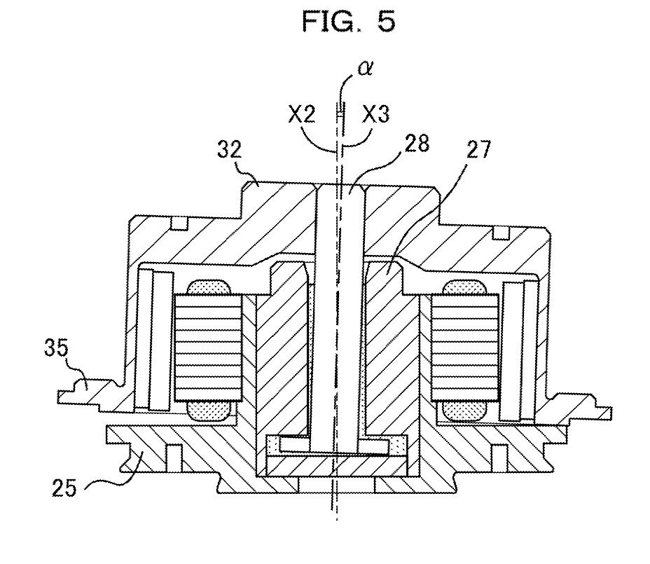

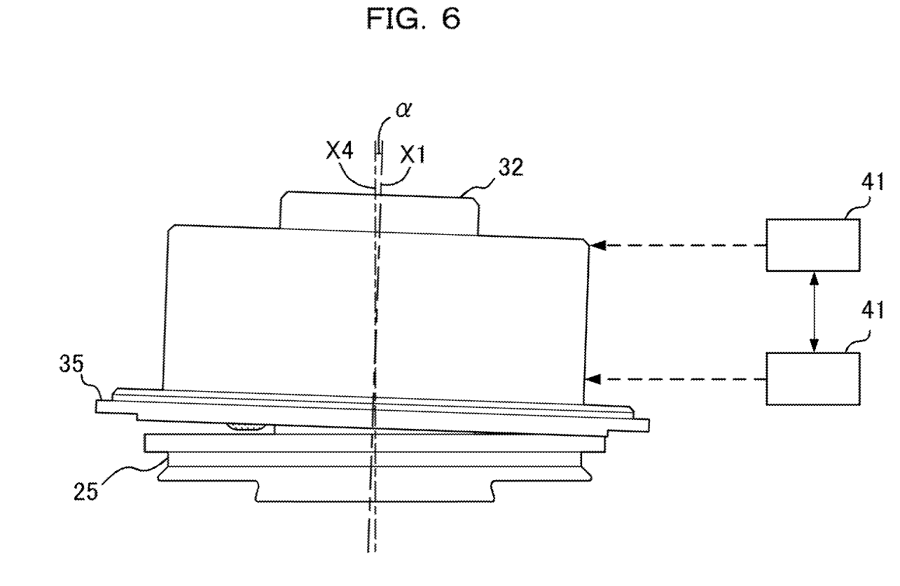

As described above, a desired space between the sleeve 27 and the rotation shaft 28 is filled with fluid. Therefore, when the rotation shaft 28 stops rotation, it tilts. For example, as shown in FIG. 5, the axis of the rotation shaft 28, that is, a center axis X3 of the rotor tilts by a desired tilting angle α from the center axis X2 of the stator. In other words, as shown in FIG. 6, the rotation center axis X1 of the rotor tilts by about the tilting angle α from a vertical axis X4 extending parallel to the center axis X2 of the stator. In this case, the outer peripheral surface of the spindle hub 32 is irradiated with laser light emitted from the non-contact displacement meters 41. The non-contact displacement meters 41 move up and down parallel to the center axis X2 of the stator. Thus, the tilting angle α is detected by the action of the non-contact displacement meters 41.

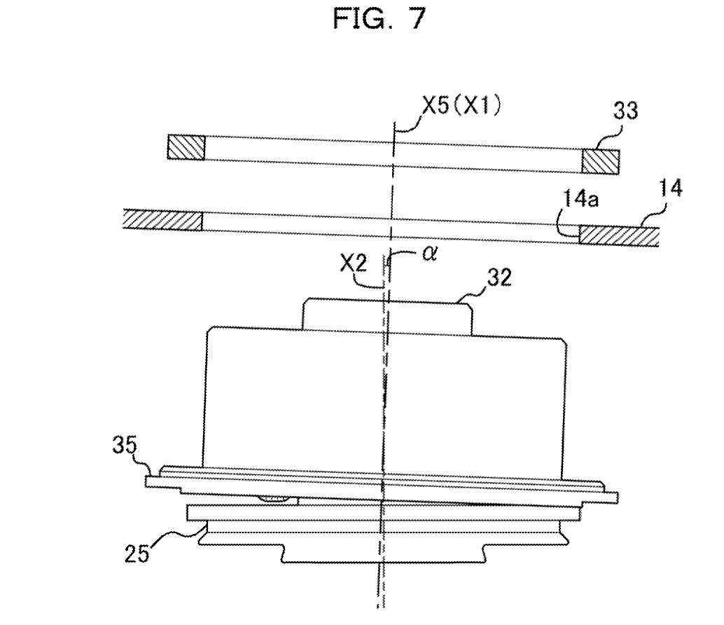

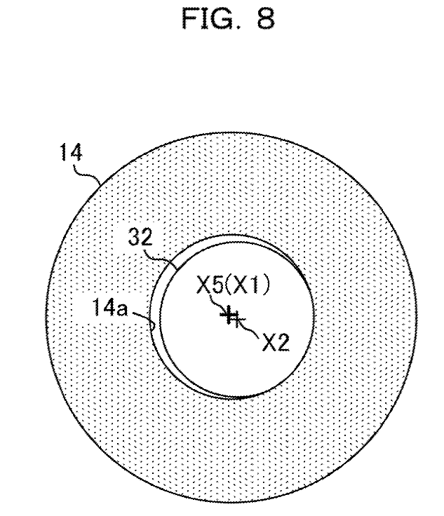

After that, a magnetic disk 14 is mounted. As shown in FIG. 7, the magnetic disk 14 is received at a through hole 14a by the spindle hub 32. The position of the magnetic disk 14 is adjusted so that the magnetic disk 14 may be received by the spindle hub 32, with reference to the tilting angle α of the rotation center axis X1. A center axis X5 of the magnetic disk 14 coincides with the rotation center axis X1 of the rotor, and is orthogonal to an imaginary plane defined along the surface of the magnetic disk 14. Similarly, the center axis of an annular spacer 33 coincides with the rotation center axis X1. As a result, as shown in FIG. 8, the center axes X5 of all magnetic disks 14 and the center axes of all annular spacers 33 coincide with the rotation center axis X1. After that, a clamp 34 is attached to the spindle hub 32. In this way, the magnetic disks 14 are mounted on the spindle hub 32.

In general, a desired gap based on the tolerance is defined between an inner peripheral surface of the through hole 14a of each magnetic disk 14 and the outer peripheral surface of the spindle hub 32. This gap allows the center axis X5 of the magnetic disk 14 to be aligned with the rotation center axis X1 of the rotor. When the center axis X5 is thus aligned with the rotation center axis X1, the magnetic disk 14 may rotate about the rotation center axis X1 of the rotor. Consequently, wobbling of the magnetic disk 14 during rotation is suppressed, regardless of wobbling of the rotor, and this increases the rotation accuracy of the magnetic disk 14. Because a component, such as a balancer, is not required, the number of components of the spindle motor 15 is not increased.

Accordingly, as described above, the mounting method includes detecting the rotation center axis of the rotor by rotating the rotor, which is rotatably supported by the stator, relative to the stator, and mounting the storage medium on the rotor while aligning the center axis of the storage medium with the rotation center axis of the rotor. That is, the rotation center axis of the rotor is detected during rotation of the rotor. When mounting the storage medium, the center axis of the storage medium is aligned with the rotation center axis of the rotor. As a result, the storage medium may rotate about the rotation center axis of the rotor during rotation of the rotor, and this suppresses wobbling of the storage medium during rotation. Because a component, such as a balancer, is not required, the rotation accuracy of the storage medium may be improved without increasing the number of components.

Furthermore, the storage medium may be mounted with reference to the tilting angle of the center axis of the rotor relative to the center axis of the stator. The tilting angle is defined when the rotor is not rotating.

For example, when a fluid bearing is incorporated in the stator, the rotor tilts relative to the stator in a stationary state, and the center axis of the rotor tilts by the desired tilting angle from the center axis of the stator. Therefore, the rotation center axis of the rotor similarly tilts by the desired tilting angle. By mounting the storage medium with reference to this tilting angle, the storage medium may be accurately aligned with the rotation center axis of the rotor. This allows the storage medium to be accurately mounted on the rotor.

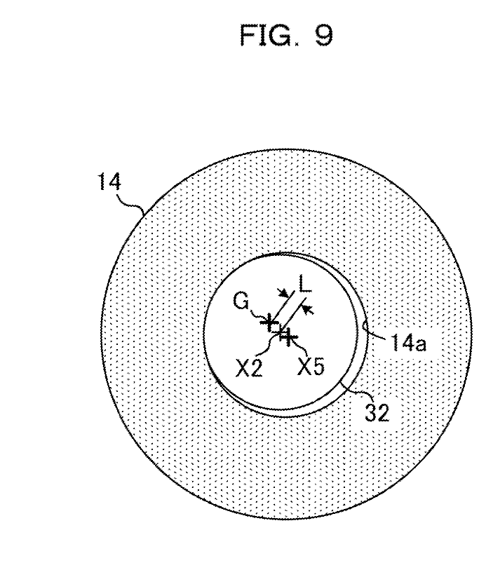

In another example embodiment, a magnetic disk 14 may be mounted based on the acceleration of the rotor, which may be detected on the basis of displacement of the spindle hub 32 measured with the non-contact displacement meters 41 during rotation of the rotor. When the acceleration of the rotor is detected in addition to the above-described rotation center axis X1 of the rotor, for example, the position of the center of gravity G of the rotor is calculated, as shown in FIG. 9. In this case, the amount of deviation L (mm) of the center of gravity G from the center axis X2 of the stator is detected. Thus, the unbalance amount of the rotor is calculated. The unbalance amount is calculated from the product ML of the mass M (g) of the rotor and the amount of deviation L (mm) of the center of gravity G.

For example, magnetic disks 14 are mounted on the spindle hub 32 based on an unbalance amount of 1.0 g·mm is calculated. One magnetic disk 14 has a mass of, for example, 10 g. Therefore, as shown in FIG. 8, the center axis X5 of one magnetic disk 14 is placed at a position deviating by a deviation amount of 0.1 mm from the center axis X2 of the stator in a direction opposite the deviating direction of the center of gravity G of the rotor. After that, the remaining three magnetic disks 14 are mounted on the spindle hub 32. The center axes X5 of the three magnetic disks 14 coincide with the rotation center axis X1. The magnetic disks 14 are thus mounted with reference to the tilting angle α of the rotation center axis X1 of the rotor, in a manner similar to the above.

According to this example embodiment for mounting the magnetic disks 14, a desired gap based on the tolerance is defined between the inner peripheral surface of the through hole 14a of each magnetic disk 14 and the outer peripheral surface of the spindle hub 32. Using this gap, the magnetic disk 14 is placed at a position deviating from the center axis X2 of the stator by a desired deviation amount in accordance with the unbalance amount of the rotor. As a result, the centers of gravity of the rotor and the magnetic disk 14 may coincide with the center axis X2 of the stator. Thus, the unbalance amounts of the rotor and the magnetic disk 14 are set at 0 g·mm. This reduces wobbling of the magnetic disk 14 during its rotation, and further improves the rotation accuracy of the magnetic disk 14. Because a component, such as a balancer, is not required, the number of components of the spindle motor 15 is not increased.

This example embodiment may be applicable in cases where the spindle motor exhibits an unbalance amount (g·mm) of the center of gravity G of the rotor is not negligible, and a higher rotation accuracy including a smaller unbalance amount (g·mm) of the center of gravity G of the rotor is specified. In such cases, instead of changing the position of one magnetic disk 14, the positions of a plurality of magnetic disks 14 may be changed in accordance with the position of the center of gravity G of the rotor. This change may remove the unbalance amount of the center of gravity G of the rotor.

Displacement of the spindle hub 32 may be detected by image recognition, instead of using the non-contact displacement meters 41. Further, the above-described fluid bearing 26 incorporated in the spindle motor 15 may be replaced with a ball bearing as an example. In this spindle motor 15, even when the rotation of the rotor stops, the axis of the rotation shaft 28 coincides with the center axis X2 of the bracket 25. Therefore, the tilting angle α is set at 0°, and no measurement of the tilting angle α is performed, which then shortens the time taken to mount the magnetic disks 14. Further, the bracket 25 may be provided integrally with the base 13 in the HDD 11. In this way, the stator of the spindle motor 15 may include the base 13 and the bracket 25.

Accordingly, in this example embodiment, the mounting method for a magnetic disk 14 includes detecting the amount of deviation of the center of gravity of the rotor from the center axis of the stator by rotating the rotor, which is rotatably supported by the stator, relative to the stator, and mounting the storage medium on the rotor while deviating the center axis of the storage medium from the center axis of the stator in accordance with the amount of deviation in the direction opposite the direction in which the center of gravity deviates from the center axis of the stator.

That is, the center of gravity of the rotor is detected during rotation of the rotor. As a result, the amount of deviation of the center of gravity from the center axis of the stator is detected. When mounting the storage medium, the center axis of the storage medium deviates from the center axis of the stator in accordance with the amount of deviation in the direction opposite the direction in which the center of gravity deviates from the center axis of the stator. Consequently, the centers of gravity of the rotor and the storage medium coincide with the center axis of the stator. As a result, the deviation, or the unbalance of the center of gravity of the rotor is removed or at least reduced, and the storage medium may rotate about the center axis of the stator. In turn, this may reduce wobbling of the storage medium during rotation. Again, because a component, such as a balancer, is not required, the rotation accuracy of the storage medium may be improved without increasing the number of components.

Also, the storage medium may be mounted with reference to the tilting angle of the rotation center axis of the rotor relative to the center axis of the stator. The tilting angle is defined when the rotor is not rotating.

For example, when a fluid bearing is incorporated in the stator, the rotor tilts relative to the stator in a stationary state, and the center axis of the rotor tilts by the desired tilting angle from the center axis of the stator. Therefore, the rotation center axis of the rotor similarly tilts by the desired tilting angle. By mounting the storage medium with reference to the tilting angle, the storage medium may be accurately aligned with the rotation center axis of the rotor. This allows the storage medium to be accurately mounted on the rotor.

Accordingly, various example embodiments as described herein commonly include a detection of the tilting angle of the center axis of the rotor, which is rotatably supported by the stator, from the center axis of the stator while the rotor is not rotating, and a mounting of the storage medium on the rotor while aligning the center axis of the storage medium with the rotation center axis of the rotor according to the detected tilting angle.

For example, when a fluid bearing is incorporated in the stator, the rotor tilts relative to the stator in a stationary state, and the center axis of the rotor tilts by the desired tilting angle from the center axis of the stator. Therefore, the rotation center axis of the rotor similarly tilts by the desired tilting angle. By mounting the storage medium with reference to the tilting angle, the storage medium may be accurately aligned with the rotation center axis of the rotor. This allows the storage medium to be accurately mounted on the rotor.

Many features and advantages of the embodiments of the present invention are apparent from the detailed specification and, thus, it is intended by the appended claims to cover all such features and advantages of the embodiments that fall within the true spirit and scope thereof. Further, because numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A storage-medium mounting method comprising:
detecting a rotation center axis of a rotor by rotating the rotor relative to a stator, the rotor being rotatably supported by the stator; and
mounting a storage medium on the rotor while aligning a center axis of the storage medium with the rotation center axis of the rotor.

2. The storage-medium mounting method according to claim 1, wherein the storage medium is mounted with further reference to a tilting angle of a center axis of the rotor relative to a center axis of the stator, the tilting angle being defined at a time that the rotor is not rotating.

3. The storage-medium mounting method according to claim 2, further comprising:
providing a fluid bearing between the rotor and the stator that contributes to the tilting angle of the center axis of the rotor.

4. A storage-medium mounting method comprising:
detecting an amount of deviation of a center of gravity of a rotor from a center axis of a stator by rotating the rotor relative to the stator, the rotor being rotatably supported by the stator; and
mounting a storage medium on the rotor while deviating a center axis of the storage medium from the center axis of the stator in accordance with the amount of deviation in a direction opposite a direction in which the center of gravity of the rotor deviates from the center axis of the stator.

5. The storage-medium mounting method according to claim 4, wherein the storage medium is mounted with reference to a tilting angle of a center axis of the rotor relative to the center axis of the stator, the tilting angle being defined at a time that the rotor is not rotating.

6. The storage-medium mounting method according to claim 5, further comprising:
providing a fluid bearing between the rotor and the stator that contributes to the tilting angle of the center axis of the rotor.

7. The storage-medium mounting method according to claim 4, wherein detecting an amount of deviation of the center of gravity of the rotor comprises:
detecting an acceleration of the rotor as the rotor is rotating; and
detecting the amount of deviation of the center of gravity of the rotor based on the detected acceleration of the rotor.

8. A storage-medium driving apparatus comprising:
a motor that includes a stator and a rotor, the rotor rotatably supported by the stator;
a storage medium mounted on the rotor such that a center axis of the storage medium is aligned with a rotation center axis of the rotor, wherein the rotation center axis of the rotor is a center of an axis of rotation of the rotor during a rotation of the rotor relative to the stator.

9. The storage-medium driving apparatus according to claim 8, wherein:
at stationary position, a center axis of the rotor is tilted at a tilting angle relative to a center axis of the stator.

10. The storage-medium driving apparatus according to claim 9, wherein the motor further includes a fluid bearing provided in between a surface of the rotor and a surface of the stator.
